(19) United States
(12) Patent Application Publication
(10) Pub. No.: US 2016/0052324 A1
(43) Pub. Date: Feb. 25, 2016

(54) PRINTING PAPER, METHOD FOR MANUFACTURING PRINTING PAPER, APPARATUS FOR MANUFACTURING PRINTING PAPER, PRINTING METHOD, AND PRINTING SYSTEM

(71) Applicant: SCREEN HOLDINGS CO., LTD., Kyoto-shi (JP)

(72) Inventor: Hiroshi IWASA, Kyoto-shi (JP)

(21) Appl. No.: 14/780,522

(22) PCT Filed: Sep. 13, 2013
(86) PCT No.: PCT/JP2013/074786

§ 371 Date: Sep. 25, 2015

(30) Foreign Application Priority Data
Mar. 26, 2013 (JP) 2013-064513

(51) Int. Cl. B41M 5/52; B41J 2/01; B05B 15/00; B05D 3/00

(52) U.S. Cl. CPC B41M 5/5245; B05D 3/007; B41J 2/01; B05B 15/00

(57) ABSTRACT

Printing paper according to the present invention includes a base material and a coating layer disposed on the base material and being capable of receiving an oil-based ink, and the coating layer includes, in an upper portion thereof, an ink receiving layer containing a cationic polymer and being capable of receiving the water-base ink by allowing the water-based ink to penetrate into the ink receiving layer. When ejected onto the printing paper, the water-based ink penetrates into the ink receiving layer included in the upper portion of the coating layer and is received, so that bleeding of the water-based ink is suppressed. The printing paper can be manufactured at low costs without containing expensive materials such as inorganic fine particles. The surface condition of the coated paper for offset printing can thus be modified so as to be suitable for the water-based ink at low costs.

### TECHNICAL FIELD

The present invention relates to printing technology using a water-based ink.

### BACKGROUND ART

Printing systems ejecting a water-based ink, such as a water-based dye ink and a water-based pigmented ink, have become popular in recent years in terms of environmental conservation. Offset printing paper is coated paper manufactured by coating a surface of a base material such as pulp with a coating layer enhancing fixability of an oil-based ink. The coating layer contains calcium carbonate, kaolin, styrene-butadiene rubber (SBR), and the like, and has been calendared to have glossiness. The offset printing paper is widely used and inexpensive, but causes deterioration of image quality, such as bleeding and insufficient density, when the water-based ink is ejected thereon. Problems of deterioration of water resistance, deterioration of rubfastness, and the like also arise. To address these problems, various types of inkjet-only paper having enhanced fixability and dryability of the water-based ink have been used in the printing systems.

The inkjet-only paper is manufactured by forming, on a base material such as pulp, a coating (an anchor coating) layer enhancing fixability of the water-based ink. The coating layer is formed by coating the base material with a coating agent (also referred to as a “coating solution”) containing inorganic fine particles such as silica, a hydrophilic binder such as polyvinyl alcohol, and a dispersing agent for maintaining dispersion of the inorganic fine particles. The coating layer thus formed has enhanced fixability of the water-based ink as the water-based ink is absorbed into a gap between inorganic fine particles attached to printing paper, and also has enhanced glossiness of the printing paper as regular reflection is performed on surfaces of the inorganic fine particles. Such inkjet-only paper, however, is more expensive than typical coated paper for offset printing.

Furthermore, in printing performed onto thick paper typified by paper used for packaging, such as cardboard, a method of ejecting an UV ink onto the thick paper by the inkjet printing system is commonly used, as higher rubfastness, water resistance, and the like than those required in printing performed onto the offset printing paper are required. The UV ink, however, has an odor, and thus has limited application as the thick paper printed with the UV ink is unsuitable for food packaging, for example. It is therefore desirable to use the printing method of ejecting the water-based ink by the inkjet printing system also in the printing performed onto the thick paper, but thick inkjet-only paper is currently seldom circulated.

For example, an inkjet printer disclosed in Patent Document 1 includes a surface treatment mechanism that stores beforehand a coating agent modifying a surface condition of typical coated paper for printing, such as offset printing paper, so that the surface condition is suitable for the water-based ink, and coats the printing paper with the coating agent. The inkjet printer performs coating with the coating agent prior to printing to perform the printing after modifying the surface condition of the typical printing paper so that the surface condition is suitable for the water-based ink, and to thereby achieve reduction of printing costs.

### PRIOR ART DOCUMENT

### Patent Document

Patent Document 1: Japanese Patent Application Laid-Open Publication No. 5-261912

### SUMMARY OF INVENTION

### Problems to be Solved by the Invention

However, even the method disclosed in Patent Document 1 has a problem of an increase in costs of manufacturing the printing paper attributable to the coating agent containing inorganic fine particles and the like, resulting in an increase in printing costs.

The present invention has been conceived to solve these problems, and aims to provide technology for modifying the surface condition of the coated paper for offset printing so that the surface condition is suitable for the water-based ink at low costs.

### Means for Solving the Problems

To solve the above-mentioned problems, printing paper according to the first aspect includes: a base material; and a coating layer disposed on the base material and being capable of receiving an oil-based ink, and the coating layer includes, in a surface-side portion thereof, an ink receiving layer containing a cationic polymer and being capable of receiving a water-based ink by allowing the water-based ink to penetrate into the ink receiving layer.

Printing paper according to the second aspect is the printing paper according to the first aspect, wherein the ink receiving layer is disposed so as to have a thickness of 5 μm or more from a surface of the coating layer.

Printing paper according to the third aspect is the printing paper according the first or second aspect, wherein the cationic polymer is selected from the group consisting of an allylamine hydrochloride polymer, a methyldiallylamine hydrochloride polymer, a quaternary ammonium salt polymer, an alkylamine polymer, a polyamine condensate, and a polydiallyldimethyl ammonium chloride.

A method for manufacturing printing paper according to the fourth aspect includes: a coating step of coating a coating layer of coated paper with a coating solution so that the coating solution penetrates into a surface-side portion of the coating layer, the coating solution penetrating into the coating layer so as to form an ink receiving layer in the coating layer, the coated paper including a base material and the coating layer that is disposed on the base material, contains a cationic polymer, and is capable of receiving an oil-based ink, the ink receiving layer receiving a water-based ink by allowing the water-based ink to penetrate into the ink receiving layer; and a drying step of drying the coated paper coated with the coating solution.

A method for manufacturing printing paper according to the fifth aspect is the method for manufacturing the printing paper according to the fourth aspect, wherein the coating step is a step of coating the coating layer with the coating solution in an amount sufficient to penetrate into the coating layer to a depth of 5 μm or more from a surface of the coating layer.

A method for manufacturing printing paper according to the sixth aspect is the method for manufacturing the printing paper according to the fourth or fifth aspect, wherein the coating solution contains an additive that increases a speed at which the coating solution penetrates into the coating layer.

A method for manufacturing printing paper according to the seventh aspect is the method for manufacturing the printing paper according to any one of the fourth to sixth aspects, wherein the cationic polymer is selected from the group consisting of an allylamine hydrochloride polymer, a methyldiallylamine hydrochloride polymer, a quaternary ammonium salt polymer, an alkylamine polymer, a polyamine condensate, and a polydiallyldimethyl ammonium chloride.

An apparatus for manufacturing printing paper according to the eighth aspect includes: a supplying unit supplying a coating solution that penetrates into a coating layer of coated paper so as to form an ink receiving layer in the coating layer, the coated paper including a base material and the coating layer that is disposed on the base material, contains a cationic polymer, and is capable of receiving an oil-based ink, the ink receiving layer receiving a water-based ink by allowing the water-based ink to penetrate into the ink receiving layer; and a coating unit coating the coating layer with the coating solution supplied by the supplying unit so that the coating solution penetrates into a surface-side portion of the coating layer.

An apparatus for manufacturing printing paper according to the ninth aspect is the apparatus for manufacturing the printing paper according to the eighth aspect, wherein the coating unit coats the coating layer with the coating solution in an amount sufficient to penetrate into the coating layer to a depth of 5 μm or more from a surface of the coating layer.

An apparatus for manufacturing printing paper according to the tenth aspect is the apparatus for manufacturing the printing paper according to the eighth or ninth aspect, wherein the coating solution contains an additive that increases a speed at which the coating solution penetrates into the coating layer.

An apparatus for manufacturing printing paper according to the eleventh aspect is the apparatus for manufacturing the printing paper according to any one of the eighth to tenth aspects, further including a drying unit drying the coated paper coated with the coating solution.

An apparatus for manufacturing printing paper according to the twelfth aspect is the apparatus for manufacturing the printing paper according to any one of the eighth to eleventh aspects, wherein the cationic polymer is selected from the group consisting of an allylamine hydrochloride polymer, a methyldiallylamine hydrochloride polymer, a quaternary ammonium salt polymer, an alkylamine polymer, a polyamine condensate, and a polydiallyldimethyl ammonium chloride.

A printing method according to the thirteenth aspect includes: a coating step of coating a coating layer of coated paper with a coating solution so that the coating solution penetrates into a surface-side portion of the coating layer, the coating solution penetrating into the coating layer so as to form an ink receiving layer in the coating layer, the coated paper including a base material and the coating layer that is disposed on the base material, contains a cationic polymer, and is capable of receiving an oil-based ink, the ink receiving layer receiving a water-based ink by allowing the water-based ink to penetrate into the ink receiving layer; a drying step of drying the coated paper coated with the coating solution; and an ink ejecting step of ejecting the water-based ink onto the coated paper as dried.

A printing method according to the fourteenth aspect is the printing method according to the thirteenth aspect, wherein the cationic polymer is selected from the group consisting of an allylamine hydrochloride polymer, a methyldiallylamine hydrochloride polymer, a quaternary ammonium salt polymer, an alkylamine polymer, a polyamine condensate, and a polydiallyldimethyl ammonium chloride.

A printing system according to the fifteenth aspect includes: a supplying unit supplying a coating solution that penetrates into a coating layer of coated paper so as to form an ink receiving layer in the coating layer, the coated paper including a base material and the coating layer that is disposed on the base material, contains a cationic polymer, and is capable of receiving an oil-based ink, the ink receiving layer receiving a water-based ink by allowing the water-based ink to penetrate into the ink receiving layer; a coating unit coating the coating layer with the coating solution supplied by the supplying unit so that the coating solution penetrates into a surface-side portion of the coating layer; a drying unit drying the coated paper coated with the coating solution; and an ink ejecting unit ejecting the water-based ink onto the coated paper dried by the drying unit.

A printing system according to the sixteenth aspect is the printing system according to the fifteenth aspect, wherein the cationic polymer is selected from the group consisting of an allylamine hydrochloride polymer, a methyldiallylamine hydrochloride polymer, a quaternary ammonium salt polymer, an alkylamine polymer, a polyamine condensate, and a polydiallyldimethyl ammonium chloride.

### Effects of the Invention

According to the present invention, the printing paper includes: the base material; and the coating layer disposed on the base material and being capable of receiving the oil-based ink, and the coating layer includes, in the surface-side portion thereof, the ink receiving layer containing the cationic polymer and being capable of receiving the water-based ink by allowing the water-based ink to penetrate into the ink receiving layer. When ejected onto the printing paper, the water-based ink penetrates into the ink receiving layer included in an upper portion of the coating layer and is received, so that bleeding of the water-based ink is suppressed. The printing paper can be manufactured at low costs without containing expensive materials such as inorganic fine particles. As a result, the surface condition of the coated paper for offset printing can be modified so as to be suitable for the water-based ink at low costs.

### BRIEF DESCRIPTION OF DRAWINGS

FIG. 1 shows an example of general configuration of a printing system according to an embodiment.

FIG. 2 shows an example of general configuration of a coating apparatus shown in FIG. 1.

FIG. 3 is a schematic cross section illustrating configuration of coated paper for offset printing.

FIG. 4 is a schematic cross section illustrating the state of the coated paper in FIG. 3 being coated with a coating solution.

FIG. 5 is a schematic cross section illustrating configuration of printing paper according to the embodiment.

FIG. 6 shows an example of bleeding of an ink on the coated paper for offset printing.

FIG. 7 shows an example of bleeding of an ink on the printing paper according to the embodiment.

FIG. 8 shows an example of bleeding of an ink on the printing paper according to the embodiment.

FIG. 9 shows an example of bleeding of an ink on the printing paper according to the embodiment.

FIG. 10 shows, in tabular form, examples of bleeding of an ink on the coated paper for offset printing and on the printing paper according to the embodiment.

FIG. 11 shows, in tabular form, examples of bleeding of an ink on the coated paper for offset printing and on the printing paper according to the embodiment.

FIG. 12 shows another example of general configuration of a coating unit shown in FIG. 2.

FIG. 13 shows an example of general configuration of a printing system according to a modification.

FIG. 14 shows an example of an operational flow of the printing system according to the embodiment.

FIG. 15 shows an example of an operational flow of the printing system according to the embodiment.

FIG. 16 shows an example of an operational flow of the printing system according to the embodiment.

### DESCRIPTION OF EMBODIMENTS

The following describes an embodiment of the present invention based on the drawings. Parts having similar configuration and functions bear the same reference sign in the drawings, and description thereof is not repeated below. Each of the drawings is a schematic diagram, and, for example, the sizes of and the positional relationship among objects displayed in each of the drawings are not necessarily accurate. For description of directions, three perpendicular axes, namely X, Y, and Z axes, or two perpendicular axes, namely the X and Z axes, are shown in some of the drawings. The X and Z axes extend horizontally, and the Y axis extends vertically (a +Y direction is an upward direction).

<A-1. Configuration of Printing System 100A>

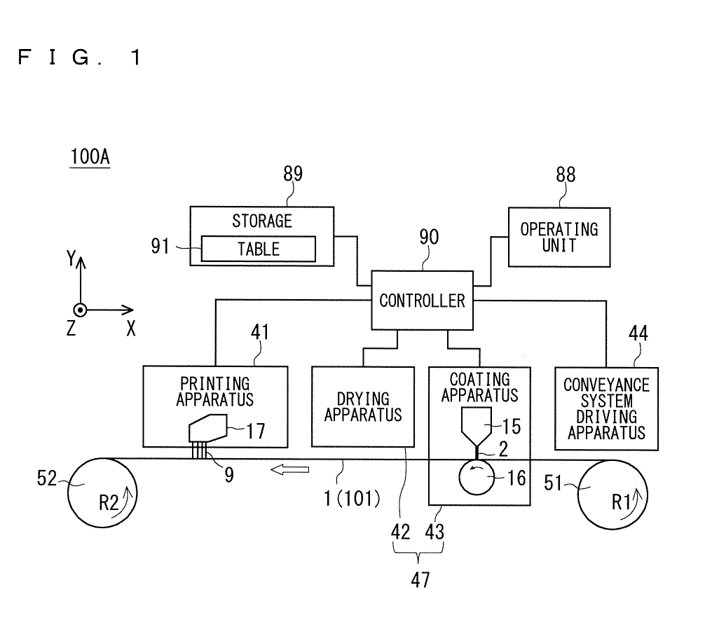

FIG. 1 shows an example of general configuration of a printing system 100A according to an embodiment. The printing system 100A is an apparatus that performs printing, by the inkjet printing system, with an ink 9 onto printing paper 101 manufactured by coating coated paper 1 for offset printing (“offset printing paper”) with a coating solution 2. The ink 9 is a water-based ink, such as a water-based dye ink and a water-based pigmented ink.

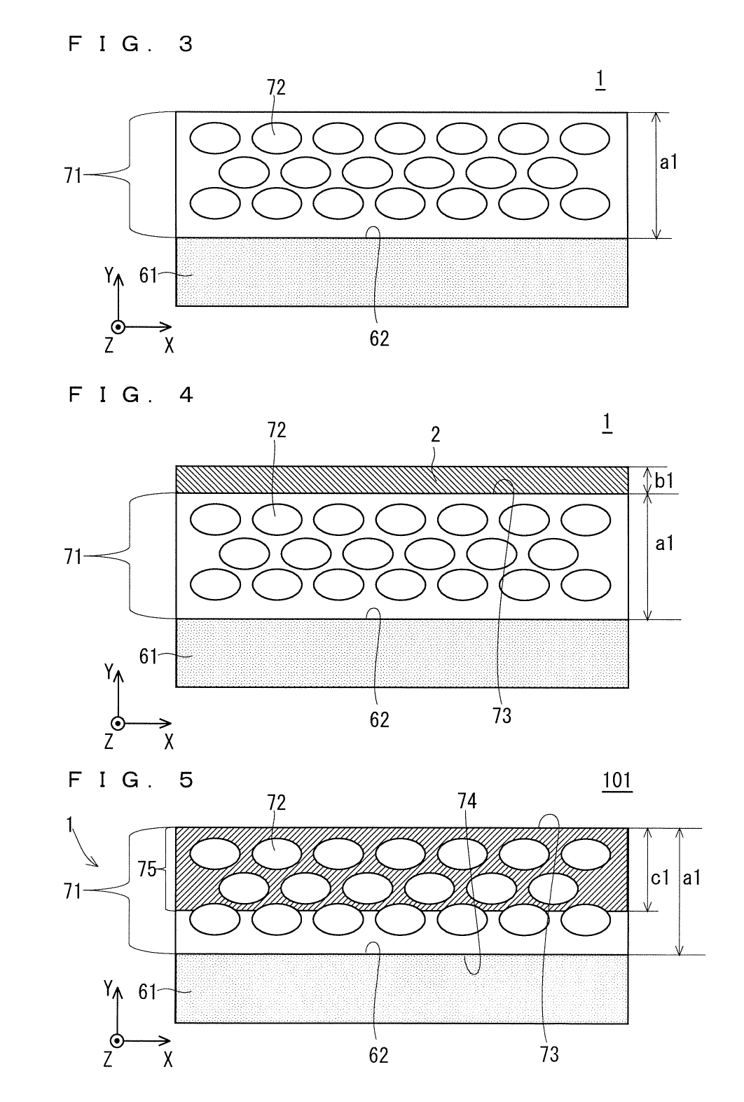

FIG. 3 is a schematic cross section illustrating configuration of the coated paper 1 for offset printing. The coated paper 1 is printing paper manufactured by forming, on a base material 61 (on an upper surface 62 of the base material 61) such as pulp, a coating layer 71 improving fixability of an oil-base ink used in offset printing. The coating layer 71 is a layer formed by binding, with a binder, kaolin entering into gaps between particles 72 of calcium carbonate, styrene-butadiene rubber (SBR), and the like, and has been calendared to have glossiness. The coating layer 71 typically has a thickness al of approximately 20 μm to 25 μm.

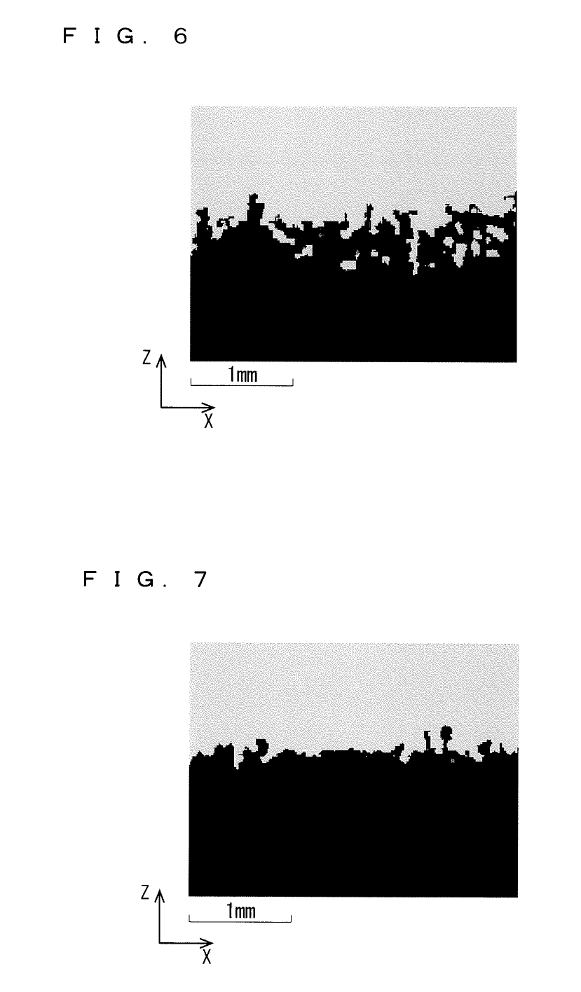

As shown in FIG. 1, the printing system 100A mainly includes a printing apparatus 41, an apparatus 47 for manufacturing the printing paper 101, a conveyance system driving apparatus 44, conveyance rollers 51 and 52, an operating unit 88, a storage 89, and a controller 90, for example. The manufacturing apparatus 47 includes a drying apparatus 42 and a coating apparatus 43. The manufacturing apparatus 47 coats the coating layer 71 of the coated paper 1 with the coating solution 2, allows the coating solution 2 to penetrate into the coating layer 71, and dries the coating solution 2 to manufacture the printing paper 101 (FIG. 5) that is the coated paper 1 in which the coating layer 71 includes an ink receiving layer 75 having enhanced fixability of the water-based ink.

The printing apparatus 41 mainly includes an inkjet head (“ink ejecting unit”) 17. The inkjet head 17 is movable in a Z-axis direction (main scanning direction), and performs printing onto the printing paper 101 by ejecting the ink 9 by the inkjet printing system while moving in the Z-axis direction relative to the printing paper 101 in accordance with control performed by the controller 90. As the inkjet head 17, an inkjet head including a plurality of nozzles arranged, along the Z axis, over the length equal to or greater than the width of the printing paper 101, and performing printing by ejecting the ink 9 from the nozzles may be used.

The drying apparatus 42 mainly includes a blowing apparatus and a heater, which are not shown, for example. The drying apparatus 42 blows warm air onto a surface 73 of the coated paper 1 in which the coating solution 2 has penetrated into the coating layer 71 to dry the coating solution 2. The dried coating solution 2 forms, in the coating layer 71 of the coated paper 1, the ink receiving layer 75 that is capable of receiving the water-based ink.

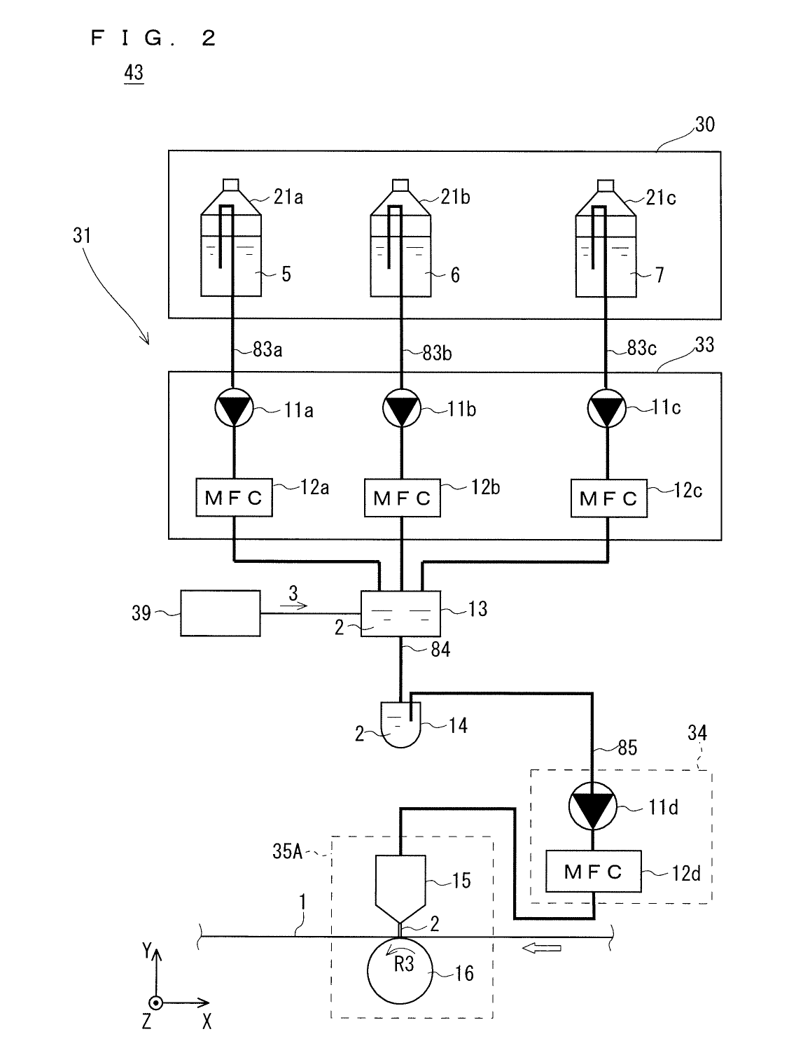

The coating apparatus 43 includes a coating unit that coats the surface 73 of the coated paper 1 with the coating solution 2. The coating unit is embodied, for example, by a coating unit 35A (FIG. 2) mainly including a coating nozzle 15 and a support roller 16. The coating apparatus 43 coats the coating layer 71 of the coated paper 1 with the coating solution 2 in accordance with control performed by the controller 90 while moving the coating unit in the X-axis direction relative to the coated paper 1. The coating solution 2 penetrates into the coating layer 71 of the coated paper 1, and is dried to form the receiving layer (“ink receiving layer”) 75 (FIG. 5) improving fixability of the ink 9. The coating solution 2 is, for example, an aqueous solution containing an ink fixing agent such as a cationic polymer, a hydrophilic solvent such as isopropyl alcohol, a surface-active agent, and the like.

FIG. 4 is a schematic cross section illustrating the state of the coated paper 1 being coated with the coating solution 2. FIG. 5 is a schematic cross section illustrating configuration of the printing paper 101 according to the embodiment. The thickness (“film thickness”) b1 of the coating solution 2 applied to the surface 73 of the coating layer 71 is adjusted in accordance with the depth c1 to which the coating solution 2 penetrates into the coating layer 71 (i.e., the thickness of the ink receiving layer 75) and configuration of the coating layer 71. The coating solution 2 applied to the coating layer 71 penetrates into an upper portion of the coating layer 71, i.e., a portion (an upper portion), of the coating layer 71, on the side of the surface 73, which is a printing surface. When the coated paper 1 is dried in a state in which the coating solution 2 has penetrated into the upper portion of the coating layer 71, water and alcohol in the coating solution 2 evaporate, and the cationic polymer remains in the coating layer 71 and is fixed. The ink receiving layer 75 is thus formed in a portion, of the coating layer 71, on the side of the surface 73. When the ink 9, which is an anion, is ejected onto the printing paper 101 including the ink receiving layer 75, electrical attracting force acting between the ink 9 and the cationic polymer contained in the ink receiving layer 75 allows the ink 9 to penetrate into the ink receiving layer 75 while suppressing diffusion of the ink 9 on the surface 73 of the coating layer 71. This enhances fixability of the water-based ink in the coating layer 71 including the ink receiving layer 75, and suppresses bleeding of the water-based ink. Furthermore, the coating solution 2 includes no inorganic fine particles. The costs of adjusting the coating solution 2 can thus be suppressed, for example, to be approximately one-fifth of the costs when the coating solution 2 contains inorganic fine particles. As a result, printing using the printing paper 101 can reduce the costs relating to the printing paper, and can thereby reduce the printing costs, compared to printing using the inkjet-only paper manufactured by coating the coating layer of the coated paper for offset printing with a coating agent containing dispersed inorganic fine particles to further form the anchor coating layer that is capable of receiving the water-based ink on the surface of the coating layer.

The conveyance system driving apparatus 44 mainly includes an actuator such as a motor, and a power transmission system, which are not shown. The conveyance system driving apparatus 44 drives the conveyance roller 51 (52) to rotate in a direction of an arrow R1 (R2) in accordance with control performed by the controller 90, thereby moving the coated paper 1 in a −X direction relative to the printing apparatus 41, the drying apparatus 42, and the coating apparatus 43. The coated paper 1 (printing paper 101) is wrapped around and fixed by the conveyance roller 51 at one end, and is wrapped around and fixed by the conveyance roller 52 at the other end, so that the coated paper 1 is tensioned between the conveyance roller 51 and the conveyance roller 52.

The coated paper 1 is fed out from the conveyance roller 51 by rotation of the conveyance roller 51 in the direction of the arrow R1, and is then rolled, as the printing paper 101 in which the coating layer 71 includes the ink receiving layer 75, around the conveyance roller 52 by rotation of the conveyance roller 52 in the direction of the arrow R2. That is to say, the conveyance system driving apparatus 44 is a conveyance mechanism conveying the coated paper 1 (printing paper 101) along a preset processing line. The coating apparatus 43 and the inkjet head 17, i.e., the printing apparatus 41, are respectively arranged upstream and downstream of the processing line. The drying apparatus 42 is located between the coating apparatus 43, which is located upstream of the processing line, and the inkjet head 17, which is located downstream of the processing line. That is to say, a process, performed by the drying apparatus 42, of drying the coating solution 2 is performed between a process, performed by the coating apparatus 43, of applying the coating solution 2 in the processing line, and a process, performed by the inkjet head 17, of ejecting the ink 9 in the processing line.

The operating unit 88 includes an operation button and a touch panel type display. An operator operates the operating unit 88 to input a type of the coating layer 71 of the coated paper 1, to issue instructions of various operations relating to the printing system 100A, and to set various parameters, for example.

The storage 89 is configured, for example, by readable/writable non-volatile memory, such as flash memory, and a hard disk device, and permanently stores therein information on various control parameters and various operating modes of the printing system 100A. The storage 89 also stores therein a table 91.

The table 91 is information showing correspondences between the type of the coating layer 71 of the coated paper 1 and materials (“target materials”) used to prepare the coating solution 2. Penetrability of the coating solution 2 into the coating layer 71 varies depending on the materials for and configuration of the coating layer 71. It is therefore necessary to change the type of the surface-active agent, the type of the solvent contained in the coating solution 2, and the like depending on the materials for and the configuration of the coating layer 71. A preferred type of the cationic polymer may vary depending on the type of the coating layer 71. The target materials used to prepare the coating solution 2 are thus changed depending on the type of the coating layer. The table 91 shows a mixing ratio in the coating solution 2 for each of the target materials. An index value that is physically or mathematically equivalent to the mixing ratio may be used in place of the mixing ratio. The table 91 is determined in advance through experiments and/or simulation in which models are specified, and is stored in the storage 89. The film thickness b1 of the coating solution 2 corresponding to the depth c1 to which the coating solution 2 penetrates into the coating layer 71 varies depending on the types of drug solutions contained in the coating solution 2 and the composition of the coating layer 71. Therefore, the correspondences are also determined in advance through experiments and/or simulation, and stored in the storage 89 as the table 91.

The controller 90 is configured by a typical microcomputer including a CPU, ROM, and RAM, and is electrically connected to each of the printing apparatus 41, the drying apparatus 42, the coating apparatus 43, the conveyance system driving apparatus 44, the operating unit 88, and the storage 89. The controller 90 controls the components of the printing system 100A at predetermined timings in accordance with a software program stored beforehand, to thereby control operation of the printing system 100A as a whole. The controller 90 also controls the coating apparatus 43 in accordance with the type of the coating layer 71 of the coated paper 1 with reference to the table 91 stored in the storage 89.

<A-2. Configuration of Coating Apparatus>

FIG. 2 shows an example of general configuration of the coating apparatus 43 in the printing system 100A. As shown in FIG. 2, the coating apparatus 43 mainly includes a retaining unit 30, a stock solution supplying unit 33, a mixer 13, a buffer tank 14, a coating solution supplying unit 34, the coating unit 35A, and a water supplying unit 39.

<A-2-1. Retaining Unit 30>

The retaining unit 30 (FIG. 2) individually retains a plurality of different candidate materials for the coating solution 2 that is applied to the coating layer 71 of the coated paper 1, penetrates into the coating layer 71, and forms the ink receiving layer 75 in the portion, of the coating layer 71, on the side of the surface 73. FIG. 2 illustrates three tanks 21a to 21c of a plurality of tanks for retaining the candidate materials in the retaining unit 30 as well as three candidate materials 5 to 7, of the candidate materials retained in the retaining unit 30, retained in the respective tanks 21a to 21c. The candidate materials are each in the form of liquid.

Possible candidate materials are the cationic polymer as the ink fixing agent, the surface-active agent, and the hydrophilic solvent such as isopropyl alcohol, for example. For each of drug solutions of the cationic polymer, the surface-active agent, and the solvent, the retaining unit 30 may retain therein only one type of the drug solution, or may retain therein a plurality of different types of the drug solution. Only for some of the drug solutions, a plurality of types of the drug solution may be retained. The retaining unit 30 at least retains therein the cationic polymer as the candidate material.

Examples of the cationic polymer are solutions of an allylamine hydrochloride polymer, a methyldiallylamine hydrochloride polymer, a quaternary ammonium salt polymer, an alkylamine polymer, a polyamine condensate, a polydiallyldimethyl ammonium chloride. An example of the hydrophilic solvent is a water-soluble organic solvent such as isopropyl alcohol and butyl alcohol.

Through control performed by the controller 90 with reference to the table 91, target materials used to prepare the coating solution 2 are selected from the candidate materials retained in the retaining unit 30 based on the type of the coated paper 1, and, for each of the selected target materials, the amount of the target material used to prepare the coating solution 2 is acquired by the controller 90. Specifically, the coating solution 2 is primarily composed of water 3 or a solvent, and contains approximately 5 wt % of the cationic polymer and approximately 0.1 wt % of the surface-active agent, for example. Since the coating solution 2 is usually primarily composed of water and alcohol as described above, the coating solution 2 applied to the coating layer 71 penetrates into the coating layer 71 without remaining on the surface 73 of the coating layer 71. A speed at which the coating solution 2 penetrates into the coating layer 71 can be increased by adding an additive, such as the surface-active agent and a solvent such as alcohol. Therefore, the speed at which the coating solution 2 penetrates and the amount of the additive, such as the surface-active agent and the solvent, may be stored in the table 91 in association with each other, and the controller 90 may refer to the table 91 to control the amount of the additive depending on a required penetrating speed. The coating solution 2 may only contain the water 3 and the cationic polymer.

<A-2-2. Stock Solution Supplying Unit 33>

The stock solution supplying unit 33 (FIG. 2) supplies the target materials selected by the controller 90 in accordance with the amounts acquired by the controller 90 from the retaining unit 30 to the mixer 13. Specifically, the stock solution supplying unit 33 mainly includes, for example, pairs of a pump and a mass flow controller that correspond to the respective tanks included in the retaining unit 30. In the example of FIG. 2, a pair of a pump 11a and a mass flow controller 12a, a pair of a pump 11b and a mass flow controller 12b, and a pair of a pump 11c and a mass flow controller 12c are shown. The pumps and the mass flow controllers are controlled in accordance with control performed by the controller 90, so that the selected target materials are supplied to the mixer 13 through stock solution supply pipes. Stock solution supply pipes 83a to 83c are illustrated in FIG. 2.

The controller 90 can adjust the amount of each of the target materials supplied per unit time by setting, for each of the mass flow controllers, the amount of the target material supplied by the mass flow controller per unit time.

In place of the pump, a component that sends a nitrogen gas and air into each of the tanks of the retaining unit 30 and increases pressure within the tank to pump each stock solution to the mixer 13 may be used, for example. In place of the mass flow controller, a motor-operated valve or the like that can adjust its opening through control performed by the controller 90 may be used, for example.

<A-2-3. Water Supplying Unit 39>

The water supplying unit 39 (FIG. 2) mainly includes a pair of a pump and a mass flow controller, for example. The water supplying unit 39 is supplied, through a pipe not shown, with the water 3 such as pure water purified beforehand in a user's manufacturing plant in which the printing system 100A is installed, and supplies the supplied water 3 to the mixer 13 while adjusting the amount thereof in accordance with control performed by the controller 90. The water supplying unit 39 is not limited to the one supplied with water from outside the apparatus. The water supplying unit 39 may include a tank that retains water to be supplied to the mixer 13, for example.

<A-2-4. Mixer 13>

The mixer (a “mixing unit”) 13 (FIG. 2) includes an agitator, which is not shown, such as a stirrer bar and an agitating propeller, for example. The mixer 13 mixes the target materials supplied from the stock solution supplying unit 33 with the water supplied from the water supplying unit 39 to prepare the coating solution 2. The resultant coating solution 2 is supplied to the buffer tank 14 through a main pipe 84. The agitator provided in the mixer 13 agitates the target materials having been supplied to the mixer 13 and mixed with the water to promote preparation of the coating solution 2.

<A-2-5. Coating Solution 2>

The coating solution 2 (FIG. 2) prepared in the mixer 13 is in the form of liquid so as to be applied to the coating layer 71 of the coated paper 1, penetrate into the coating layer 71, and be dried to form the ink receiving layer 75 in the portion, of the coating layer 71, on the side of the surface 73. The quantity ratio (volume ratio, weight ratio) of the target materials in the coating solution 2 has been adjusted to have a preset value through control of the stock solution supplying unit 33 performed by the controller 90 based on the table 91. The coating solution 2 contains the cationic polymer as a fixing agent for the ink 9, which is the water-based ink. The coating solution 2 is in the form of liquid so as to penetrate into the coating layer 71 formed on the upper surface 62 of the base material 61 of the coated paper 1 to form, in the coating layer 71, the ink receiving layer 75 that receives the ink 9 by allowing the ink 9 to penetrate into the ink receiving layer 75. Electrical attracting force acting between the ink 9, which is an anion, and the cationic polymer in the ink receiving layer 75 allows the ink 9 ejected onto the printing paper 101 to penetrate into and be received by the ink receiving layer 75 while suppressing diffusion of the ink 9 on the surface 73 of the coating layer 71. Bleeding of the ink 9 is thereby suppressed. Since the coated paper 1 is offset printing paper, the coating layer 71 is capable of receiving the oil-base ink.

<A-2-6. Buffer Tank 14>

The buffer tank 14 (FIG. 2) is a tank that temporarily retains the coating solution 2 prepared in the mixer 13. The buffer tank 14 is provided to prevent the shortage of the coating solution 2 to be applied that is caused by the difference between the amount of the coating solution 2 supplied to the buffer tank 14 and the amount of the coating solution 2 supplied from the buffer tank 14 to the coating unit 35A and applied. The coating solution 2 retained in the buffer tank 14 is supplied to the coating unit 35A through a main pipe 85.

<A-2-7. Coating Solution Supplying Unit 34>

The coating solution supplying unit 34 (FIG. 2) mainly includes a pair of a pump 11d and a mass flow controller 12d, for example. The coating solution supplying unit 34 supplies the coating solution 2 from the buffer tank 14 to the coating nozzle 15 through the main pipe 85 so that the coating solution 2 temporarily retained in the buffer tank 14 is applied from the coating nozzle 15 (FIG. 3) of the coating unit 35A. The amount of the coating solution 2 supplied by the mass flow controller 12d per unit time is controlled by setting of the amount provided by the controller 90.

As described above, the retaining unit 30, the stock solution supplying unit 33, the mixer 13, the buffer tank 14, the coating solution supplying unit 34, and the water supplying unit 39 operate as a supplying unit 31 supplying the coating solution 2 to the coating unit 35A.

<A-2-8. Coating Unit 35A (35B)>

The coating unit 35A (FIG. 2) mainly includes the coating nozzle 15 and the support roller 16, and coats the coating layer 71 with the coating solution 2 supplied from the supplying unit 31 so that the coating solution 2 penetrates into the portion, of the coating layer 71, on the side of the surface 73. The coated paper 1 conveyed by the conveyance rollers 51 and 52 (FIG. 1) is conveyed in the −X direction relative to the coating unit 35A while being supported by the support roller 16 that is rotatable in a direction of an arrow R3. An example of the coating nozzle 15 is a nozzle mechanism of Linearcoater (registered trademark) from Dainippon Screen Mfg. Co., Ltd. The coating nozzle 15 scans an upper surface of the coated paper 1 in a +X direction relative to the coated paper 1 while ejecting the coating solution 2 in the form of a curtain along the Z axis in accordance with the width of the coated paper 1 in the Z-axis direction. The coating solution 2 is applied to the coating layer 71 of the coated paper 1 through the scanning. The applied coating solution 2 penetrates into the coating layer 71 and is dried to form the ink receiving layer 75 in the portion, of the coating layer 71, on the side of the surface 73.

The depth c1 (FIG. 5) to which the coating solution 2 applied to the coating layer 71 penetrates into the coating layer 71 varies depending on the thickness b1 of the coating solution 2 applied to the surface 73 of the coating layer 71. The thickness b1 of the coating solution 2 is controlled by the distance between the coating nozzle 15 and the surface 73 of the coating layer 71. The distance is set by the controller 90 causing a lifting mechanism, which is not shown, to move the coating nozzle 15 upwards and downwards along the Y axis. For example, when the target value of the thickness c1 of the ink receiving layer 75 is 20 μm, and thus the coating solution 2 is required to penetrate into the coating layer 71 to a depth of 20 μm from the surface 73, the thickness b1 of the coating solution 2 applied to the coating layer 71 is approximately 5 μm to 6 μm, for example. The clearance between the coating layer 71 and the coating nozzle 15 is thus set to 5 μm to 6 μm. The film thickness b1 of the coating solution 2 corresponding to the depth c1 to which the coating solution 2 penetrates into the coating layer 71 varies depending on the type of drug solutions contained in the coating solution 2 and the composition of the coating layer 71. The correspondence is thus determined in advance through experiments and/or simulation, and stored in the storage 89 as the table 91. The controller 90 adjusts the height of the coating nozzle 15 with reference to the table 91, so that the coating unit 35A sets the amount of the coating solution 2 supplied from the supplying unit 31 to the amount that allows the coating solution 2 to penetrate into the portion, of the coating layer 71, on the side of the surface 73 to a depth of 5 μm or more from the surface 73 without being poured out from the surface 73 of the coating layer 71. The coating unit 35A thereby coats the coating layer 71 with the coating solution 2 so that the coating solution 2 penetrates into the portion, of the coating layer 71, on the side of the surface 73.

If the amount of the coating solution 2 applied to the surface 73 of the coating layer 71 exceeds the amount of the coating solution 2 that the coating layer 71 can receive, the coating solution 2 penetrates into the coating layer 71 and reaches the base material 61. This means that the formed ink receiving layer 75 reaches the base material 61. If the ink receiving layer 75 reaches the base material 61, the ink 9 ejected onto the coating layer 71 penetrates into the ink receiving layer 75 towards a lower surface 74 of the coating layer 71, and reaches the base material 61. The base material 61 such as pulp usually has a higher penetrability of the ink 9 than the coating layer 71, and thus the ink 9 that has reached the base material 61 penetrates and diffuses in the base material 61 in a direction along the upper surface 62, causing bleeding. The depth c1 to which the coating solution 2 penetrates into the coating layer 71 is thus set to be smaller than the thickness al of the coating layer 71 so that the coating solution 2 does not reach the base material 61.

In contrast, if the ink receiving layer 75 is thin, and the amount of the water-based ink that the ink receiving layer 75 can receive falls below the amount of the water-based ink ejected onto the coating layer 71, the ink 9 ejected onto the printing paper 101 cannot sufficiently penetrate into the coating layer 71, and diffuses on the surface of the printing paper 101, causing bleeding. Therefore, the depth c1 to which the coating solution 2 penetrates into the coating layer 71 (the thickness of the ink receiving layer 75) is set to be equal to or greater than 5 μm as described later.

The thickness of the ink receiving layer 75 is thus desirably set to be equal to or greater than 5 μm, and be smaller than the thickness al of the coating layer 71. The upper surface 62 itself of the base material 61 such as pulp is actually uneven, and the thickness of the coating layer 71 varies. Therefore, if the thickness al of the coating layer 71 is 25 μm, the thickness of the ink receiving layer 75 is more desirably set to be equal to approximately 15 μm to 20 μm so that an allowance of approximately 5 μm is formed between the upper surface 62 of the base material 61 and a lower surface of the ink receiving layer 75.

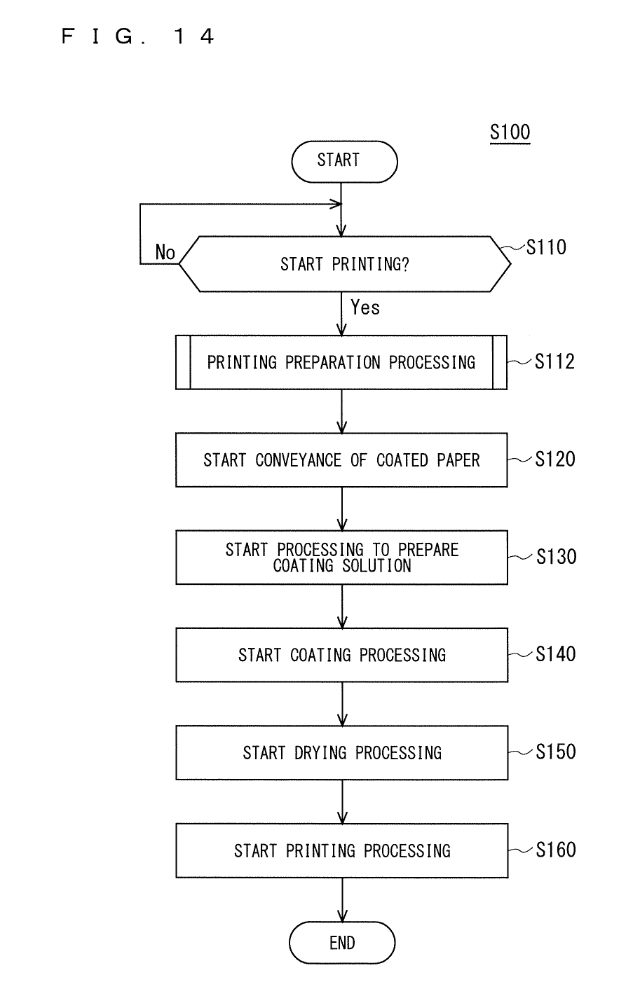

FIG. 12 shows general configuration of a coating unit 35B as another example of the coating unit 35A shown in FIG. 2. The coating unit 35B mainly includes a gravure roller 18, a pressing roller 19, and a coating solution pan 37 that collects the coating solution 2 supplied from the buffer tank 14.

In the coating unit 35B, the gravure roller 18 has many holes in its surface, and can change the amount of the coating solution 2 held on the surface by changing the size and the depth of the holes. As such, the coating unit 35B adjusts the amount of the coating solution 2 supplied from the supplying unit 31 so that the amount becomes equal to the amount that allows the coating solution 2 to penetrate into the portion, of the coating layer 71, on the side of the surface 73 without being poured out from the surface 73 of the coating layer 71, and coats the coating layer 71 with the coating solution 2. The gravure roller 18 is driven by a driving mechanism, which is not shown, controlled by the controller 90 to rotate in a direction of an arrow R4 so that the speed at which the coated paper 1 is conveyed in a direction of an arrow Yl becomes equal to a rotational movement speed on the surface of the gravure roller 18. Following the rotation, the gravure roller 18 holds the coating solution 2 collected in the coating solution pan 37 on its surface, and applies the held coating solution 2 to the coated paper 1 that comes into contact with the gravure roller 18. The pressing roller 19 is rotated in a direction of an arrow R5 so that the speed on its surface becomes equal to the speed on the surface of the gravure roller 18. The pressing roller 19 supports the coated paper 1 by pressing the coated paper 1 against the gravure roller 18 so that the coating solution 2 held on the gravure roller 18 is provided to the coated paper 1.

Use of the coating unit 35B, for example, in place of the coating unit 35A does not impair the usefulness of the present invention. In the case of using the coating unit 35B in place of the coating unit 35A, the coating solution supplying unit 34 is provided between the buffer tank 14 and the coating solution pan 37.

<A-3. Depth to which Coating Solution Penetrates (Thickness of Ink Receiving Layer) and Bleeding of Ink>

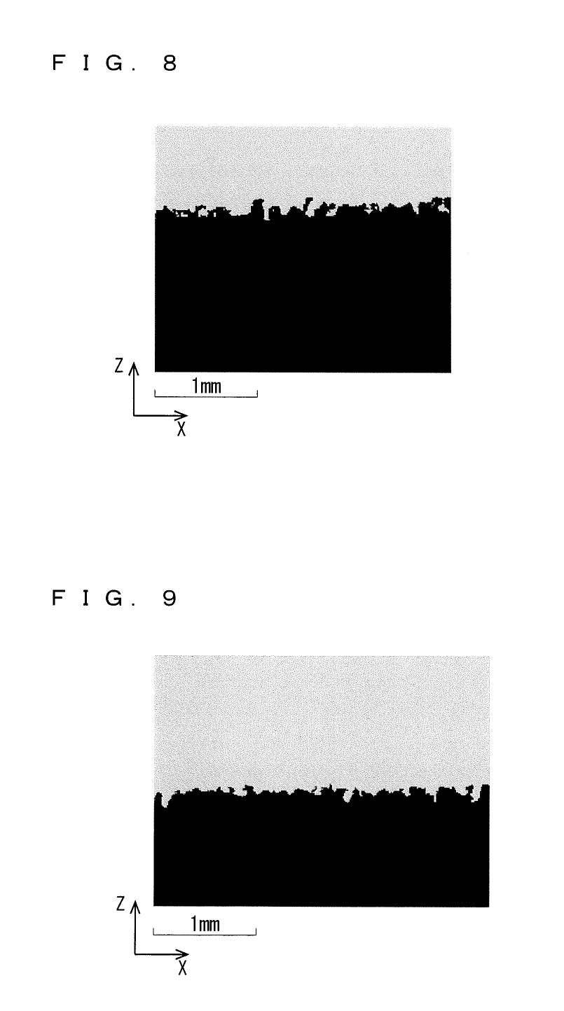

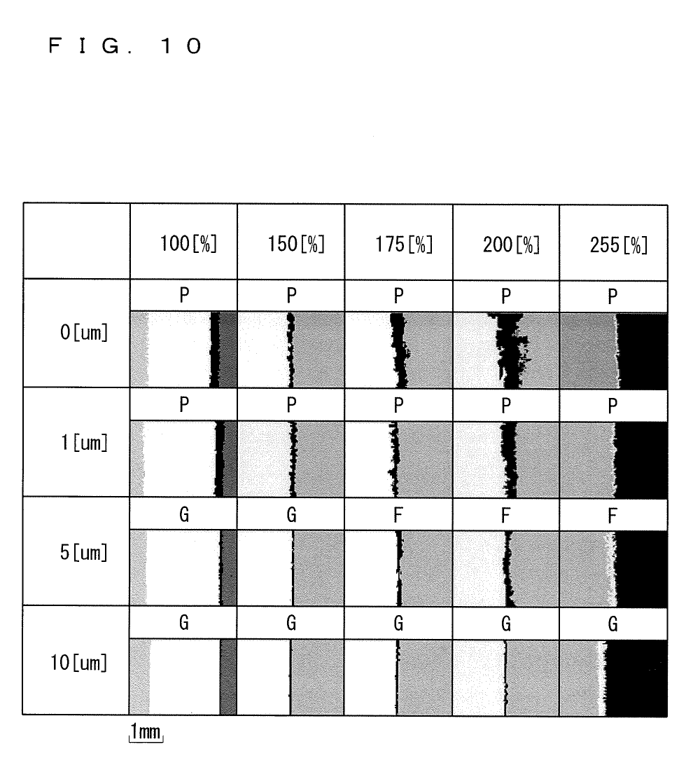

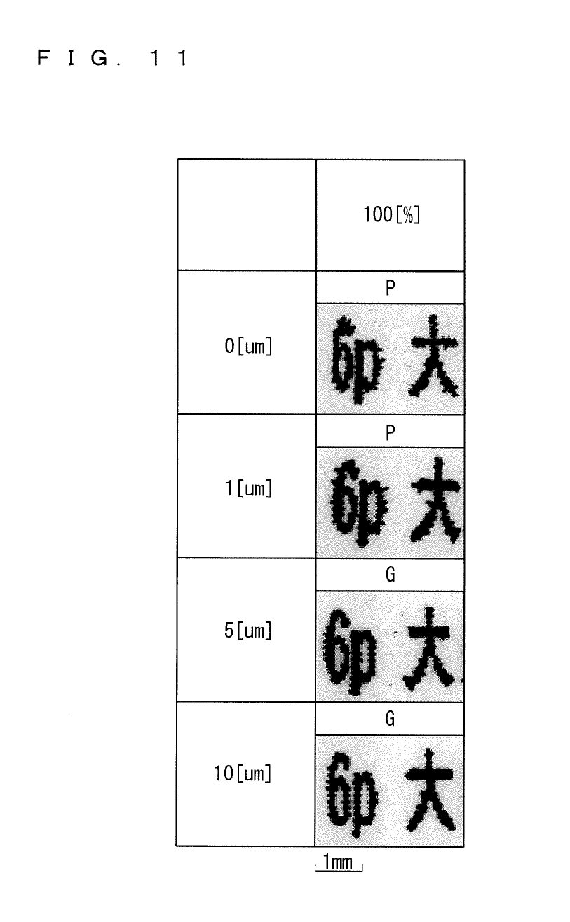

FIG. 6 shows an example of bleeding of inks on the coated paper for offset printing not including the ink receiving layer 75 (i.e., printing paper including the ink receiving layer 75 having a thickness of 0 μm). FIGS. 7, 8, and 9 show examples of bleeding of inks on sheets of the printing paper 101 including the ink receiving layers 75 having thicknesses of 1 μm, 5 μm, and 10 μm, respectively.

More specifically, FIGS. 6 to 9 show images obtained by ejecting a water-based cyan ink and a water-based magenta ink onto the coated paper for offset printing and the sheets of the printing paper 101 so that the two inks are vertically arranged in the upper half and the lower half of each of the sheets, extracting, from images showing boundaries between the two inks, regions in colors of the respective inks through image processing, and displaying the extracted regions in different colors. In each of the images, a gray part indicates a part single-color printed with the cyan ink, and a black part indicates a part single-color printed with the magenta ink. The printing rates (also referred to as “recording rates” and “area rates”) with the cyan ink and the magenta ink are each 90%. That is to say, each of the images shown in FIGS. 6 to 9 has been printed by ejecting inks at a printing rate of 90% throughout the image. The coating layer of the coated paper on which each of the images shown in FIGS. 6 to 9 has been printed has a thickness of 25 μm. As for the size of each of the images, the width of the image, i.e., the length of the image in the horizontal direction, is 3.2 mm, and the height of the image, i.e., the length of the image in the vertical direction, is shown at the same magnification as that of the width of the image. Each of the images is shown at the same magnification.

As shown in FIGS. 6 to 9, the boundary between the cyan and magenta inks is the jaggiest, i.e., the cyan and magenta inks bleed into each other the most, on the coated paper for offset printing (FIG. 6). As the thickness of the ink receiving layer 75 increases in the order of 1 μm, 5 μm, and 10 μm, the boundary between the cyan and magenta inks becomes clearer (becomes closer to a single line), and bleeding of the inks is reduced (FIGS. 6 to 9). As a result of evaluating whether bleeding in each of the images falls within an allowable range, bleeding of the inks falls within the allowable range when the ink receiving layer 75 has a thickness of 5 μm or more. This means that, at a printing rate of 90%, bleeding of adjacent inks falls within the allowable range when the ink receiving layer 75 has a thickness of 5 μm or more.

The printing rate of the ink is the area rate of halftone dots of the ejected ink, and, if the printing rates of yellow (Y), magenta (M), cyan (C), and black (K) inks are each 50%, for example, the printing rate of the inks as a whole is 200%. The printing rate in a solid part is usually set to 60% to 250%. Particularly in the case of single color printing, the printing rate in the solid part is usually set to around 60%. The ink receiving layer 75 is at least required to have a thickness that can suppress bleeding of the inks within the allowable range in printing performed at a printing rate of 60%, which corresponds to a minimum concentration allowable in most printing.

FIG. 10 shows, in tabular form, examples of bleeding of the inks on the coated paper for offset printing not including the ink receiving layer 75 (i.e., the printing paper including the ink receiving layer 75 having a thickness of 0 μm) and on the sheets of the printing paper 101 including the ink receiving layers 75 having thicknesses of 1 μm, 5 μm, and 10 μm.

The table of FIG. 10 shows 20 images in different combinations of the printing rate and the thickness of the ink receiving layer in a matrix of four rows and five columns. The images are each obtained by extracting, from an image showing a material printed with colored inks, regions in the respective colors through image processing, and appropriately converting the colors of the extracted regions into colors selected from a plurality of gray to black colors corresponding to respective levels of color strength. The coating layer of the coated paper on which each of the images shown in FIG. 10 has been printed has a thickness of 25 μm. As for the size of each of the images, the width of the image, i.e., the length of the image in the horizontal direction, is 3.2 mm, and the height of the image, i.e., the length of the image in the vertical direction, is shown at the same magnification as that of the width of the image. Each of the images is shown at the same magnification.

Five printing rates (100, 150, 175, 200, and 255 [%]) are shown in the first row of the table, and four thicknesses of the ink receiving layer (0, 1, 5, and 10 [μm]) are shown in the first column. The printing rate shown in the same column as each of the images indicates the printing rate of the image (more precisely the highest printing rate of all printing rates of inks ejected onto a number of parts of the image), and the thickness of the ink receiving layer shown in the same row as the image indicates the thickness of the ink receiving layer 75 of the printing paper on which the image has been printed. In an upper part of each of the images, a result of evaluating bleeding of the inks in the image is shown.

As the evaluation results, G (Good) represents a good image with sufficiently small bleeding, F (Fair) represents an image with bleeding that is larger than the bleeding in the image represented by G but is still allowable, and P (Poor) represents an image with bleeding that is too large to allow.

Images printed at a printing rate of 100% are each an image obtained by performing solid printing with three plain color inks, namely yellow (Y), magenta (M), and cyan (C) inks, at a printing rate of 100%. In each of the images, a second-lightest gray part at the left end is a part with the yellow ink, a lighter gray part that is the second part from the left end is a part with the magenta ink, and a gray part at the right end is a part with the cyan ink. A black part between the part with the magenta ink and the part with the cyan ink is a part in which the magenta and cyan inks bleed into each other to create a secondary color ink that is a mixture of the magenta and cyan inks. Each of the images printed at a printing rate of 100% has a higher image quality with smaller bleeding of the yellow and magenta inks when a line showing the boundary between the yellow and magenta inks is smoother, and has a higher image quality with smaller bleeding of the magenta and cyan inks when the secondary color part shown in black is smaller.

As a secondary color test pattern relating to the images shown in FIG. 10, i.e., a test pattern for images printed at a printing rate of 150% or more, a gradation pattern in which a plain color and a secondary color are arranged adjacent to each other is used as described below to facilitate detection of bleeding.

In images printed at printing rates of 150%, 175%, and 200%, second-darkest gray parts in approximately the right halves of the images are parts in which secondary color inks that are mixtures of the cyan and magenta inks ejected at the same printing rate have been ejected at printing rates of 150%, 175%, and 200% onto the sheets of the printing paper. A lightest gray part in approximately the left half of each of the images is a part in which a plain cyan ink has been ejected at a printing rate of 100% regardless of the printing rate of the secondary color ink in the right half of the image. A black part in the middle of the image is a part in which the secondary color ink that is the mixture of the cyan and magenta inks in the right half of the printing paper bleeds into the plain cyan ink in the left half of the printing paper, and is mixed with the cyan ink. Each of the images printed at printing rates of 150%, 175%, and 200% has a higher image quality with smaller bleeding of the inks when the black part in the middle of the image is smaller. An ink in a part printed at a higher printing rate is usually likely to bleed into an ink in a part printed at a lower printing rate to produce a so-called ink-on-ink state, and therefore the printing rate in the left part of the image is set to be lower than the printing rate in the right part of the image.

A black part in approximately the right half of each of images printed at a printing rate of 255% is a part in which the secondary color ink that is the mixture of the cyan, magenta, and yellow inks ejected at the same printing rate has been ejected at a printing rate of 255%. A strip-shaped light gray part in the middle of the image is a part in which a plain black (K) ink has been ejected at a printing rate of 50%. A dark gray part in approximately the left half of the image is a part in which the plain black (K) ink has been ejected at a printing rate of 85%. The part printed at a printing rate of 85% has been formed on the printing paper to increase visibility of the middle part printed at a printing rate of 50%. The secondary color ink having been ejected at a printing rate of 255% in the left half of the image bleeds into the middle part in which the black ink has been ejected at a printing rate of 50%, which is lower than 255%, to produce the ink-on-ink state. Each of the images printed at a printing rate of 255% thus has a higher image quality with smaller bleeding of the inks when the strip-shaped black part in the middle of the image is wider and clearer, and has a lower image quality with larger bleeding of the inks when the part is narrower and unclearer, in contrast to the images printed at other printing rates.

When the thickness of the ink receiving layer is the same between the image printed at a printing rate of 255% and the images printed at printing rates of 175% and 200%, bleeding is more noticeable in the images printed at printing rates of 175% and 200% than in the image printed at a printing rate of 255%. Presumably, this is because the ink ejected at a printing rate of 255% is pooled on the paper like a pond as absorption of the water-based ink into the coated paper is extremely slow, while the ink is stemmed by the part printed at a printing rate of 50%, which is greatly different from 255%, and the spread of bleeding towards the part printed at a printing rate of 85% is suppressed.

As shown in FIG. 10, bleeding of the inks becomes smaller when the ink receiving layer 75 becomes thicker in an image printed at any printing rate, and bleeding of the inks exceeds the allowable range in any of tests for the printing rates of 100% to 255% on the coated paper for offset printing not including the ink receiving layer 75 and on the printing paper 101 including the ink receiving layer 75 having a thickness of 1 μm. In contrast, bleeding of the ink falls within the allowable range on the printing paper 101 including the ink receiving layer 75 having a thickness of 5 μm or more.

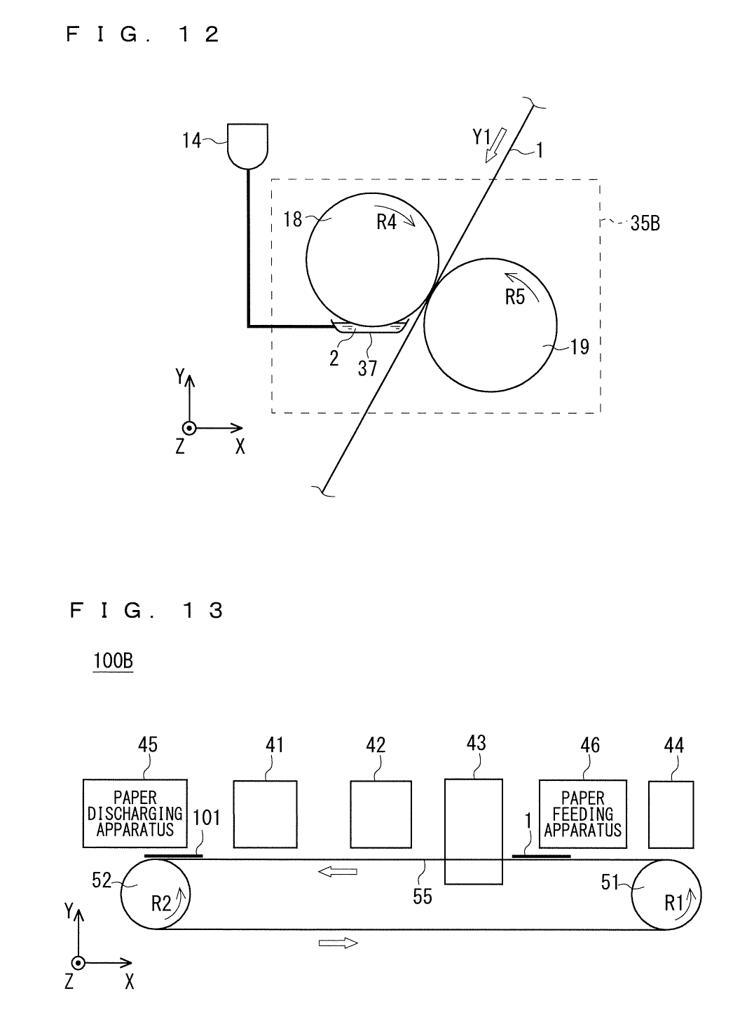

FIG. 11 shows, in tabular form, examples of bleeding of the inks on the coated paper for offset printing not including the ink receiving layer 75 (i.e., the printing paper including the ink receiving layer 75 having a thickness of 0 μm) and on the sheets of the printing paper 101 including the ink receiving layers 75 having thicknesses of 1 μm, 5 μm, and 10 μm. More specifically, the table of FIG. 11 shows four images corresponding to the ink receiving layers having different thicknesses in a matrix of four rows and one column. A test pattern of characters including an alphanumeric character and a Chinese character is used in each of the images. Since characters are usually printed at a printing rate of 100%, characters in each of the images shown in FIG. 11 are printed with the black (K) ink at a printing rate of 100% with a size of six points. The coating layer of the coated paper on which each of the images shown in FIG. 11 has been printed has a thickness of 25 μm. As for the size of each of the images, the width of the image, i.e., the length of the image in the horizontal direction, is 3.2 mm, and the height of the image, i.e., the length of the image in the vertical direction, is shown at the same magnification as that of the width of the image. Each of the images is shown at the same magnification.

The printing rate (100[%]) is shown in the first row of the table of FIG. 11, and four thicknesses of the ink receiving layer (0, 1, 5, and 10 [μm]) are shown in the first column. To each of the images, the thickness of the ink receiving layer shown in the same row corresponds. In an upper part of each of the images, a result of evaluating bleeding of the ink in the image is shown. The evaluation results are indicated at the three levels, G (Good), F (Fair), and P (Poor) by the same judgmental standard as that used in FIG. 10.

As shown in FIG. 11, also in a case where characters are printed at a printing rate of 100%, bleeding of the ink becomes smaller as the ink receiving layer 75 becomes thicker, and bleeding of the ink exceeds the allowable range on the coated paper for offset printing not including the ink receiving layer 75 and on the printing paper 101 including the ink receiving layer 75 having a thickness of 1 In contrast, bleeding of the ink falls within the allowable range on the printing paper 101 including the ink receiving layer 75 having a thickness of 5 μm or more.

Experimental results in FIGS. 6 to 11 show that an image printed at a printing rate of 90% has an image quality with bleeding suppressed within the allowable range when the ink receiving layer 75 has a thickness of 5 μm or more. It is therefore known that an image printed at a printing rate of 60% also has an image quality with bleeding suppressed within the allowable range when the ink receiving layer 75 has a thickness of 5 μm or more. The results showing that bleeding has been suppressed within the allowable range when printing is performed at a printing rate of 255% are also obtained. Bleeding can thus be suppressed within the allowable range when printing is performed at a printing rate of 250%, which is lower than 255%. That is to say, in a case of ejecting the ink onto the printing paper at a printing rate of 60% to 250% for printing, a printed image has an image quality with bleeding suppressed within the allowable range when the ink receiving layer 75 has a thickness of 5 μm or more. The printing paper 101 including the ink receiving layer 75 having a thickness of 5 μm or more is printing paper that can suppress bleeding of ink within the allowable range when printing is performed at a printing rate of 60% to 250%.

<A-4. Operation of Printing System 100A>

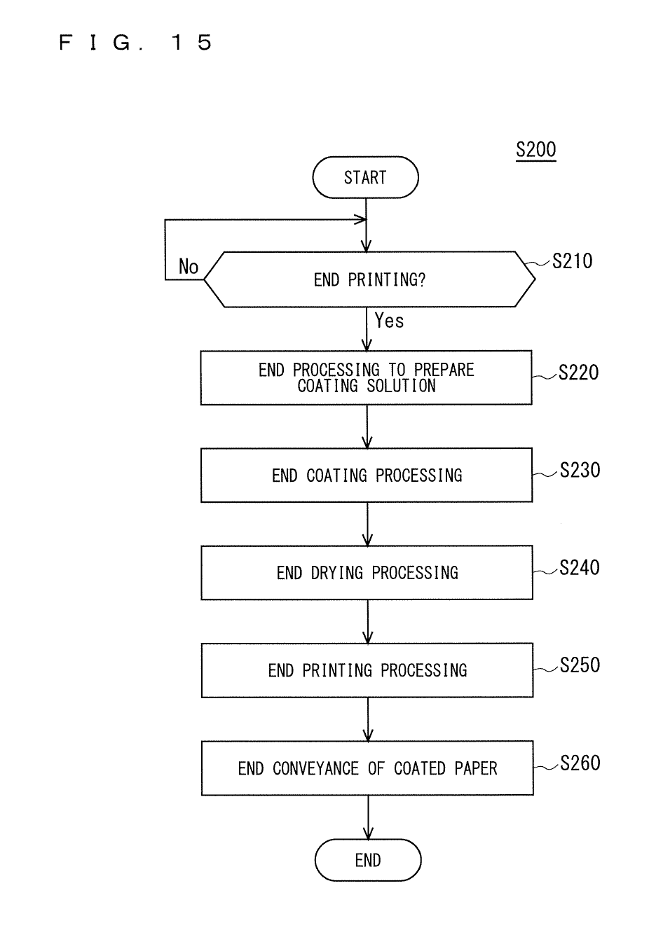

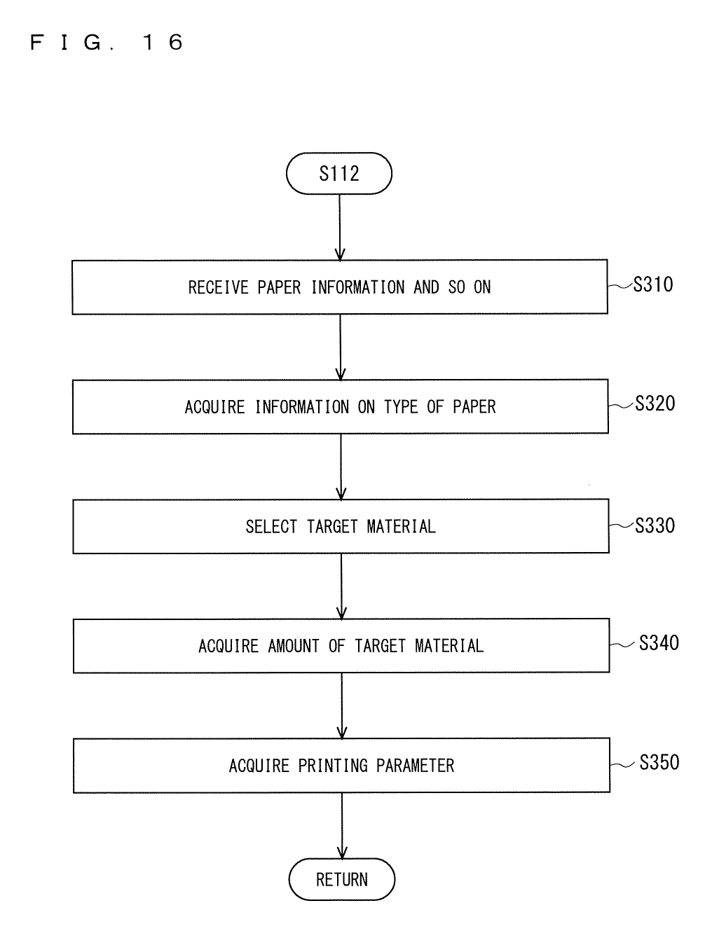

FIGS. 14 to 16 show examples of operational flows of the printing system 100A according to the embodiment. More specifically, FIG. 14 shows an example of an operational flow S100 relating to the start of printing performed by the printing system 100A, and FIG. 15 shows an example of an operational flow S200 relating the end of printing. FIG. 16 shows an example of a detailed operational flow of processing performed in step S112 of FIG. 14. The following describes operation of the printing system 100A with reference to FIGS. 14 to 16 as appropriate.

<A-4-1. Operation of Printing System 100A Relating to Start of Printing>

The controller 90 of the printing system 100A (FIG. 1) waits for various indicator signals input from the operating unit 88 in a power ON state (step S110 of FIG. 14), and shifts processing to printing preparation processing in step S112 when receiving a printing indicator signal indicating the start of printing.

As shown in FIG. 16, in step S112, the operating unit 88 first receives operation of designating paper information indicating a type and the like of the coated paper 1 (step S310). The controller 90 acquires information on the type of the paper from the operating unit 88 (step S320).

The controller 90 then selects one or more target materials used for preparation of the coating solution 2 from a plurality of candidate materials retained in the retaining unit 30 based on the type of the coated paper 1 acquired and recognized in step S320 (step S330). The controller 90 then acquires, for each of the selected target materials, the amount of the target material used for preparation of the coating solution 2 based on the type of the coated paper 1 (step S340). When there is the need to specify an order of supplying the selected target materials to the mixer 13, the supplying order is stored in the table 91, and the controller 90 controls the coating apparatus 43 based on the stored supplying order.

The controller 90 performs the processing in the above-mentioned steps S330 to S340 by referring to the table 91 stored in the storage 89. The table 91 stores therein correspondences between the type of the coating layer 71 and target materials used for preparation of the coating solution 2 for forming the ink receiving layer 75 suitable for the type of the coating layer 71. The table 91 also stores therein, for each of the target materials, the mixing ratio used when the target material is mixed with water in the mixer 13 for preparation of the coating solution 2. The controller 90 can perform the processing in steps S330 to S340 by specifying the target materials contained in the coating solution 2 based on the type of the coating layer 71 with reference to the table 91.

The controller 90 then acquires a printing parameter relating to control of ejection, performed by the inkjet head 17, of the ink corresponding to the coating solution 2 based on the recognized type of the coating layer 71 (step S350). The printing parameter includes the amount of the ink ejected per unit time, the density (printing rate) of the ink ejected per unit area, and dot control information, for example. The printing parameter is stored in the table 91, for example. The printing parameter may be stored in the storage 89 as information other than the table 91. The inkjet head 17 ejects the ink 9 onto the coated paper 1 coated with the coating solution 2 based on the printing parameter acquired by the controller 90. In a case where a target printing rate has been set in advance, for example, information on correspondences between the target printing rate and the thickness of the ink receiving layer 75 that can suppress bleeding of the ink within the allowable range may be stored in the table 91, and the controller 90 may control the coating apparatus 43 with reference to the correspondence information.

Referring back to FIG. 14, when the printing preparation processing performed in step S112 ends, the controller 90 controls the conveyance system driving apparatus 44 to cause the conveyance system driving apparatus 44 to rotate the conveyance rollers 51 and 52 to thereby start conveyance of the coated paper 1 (step S120).

The controller 90 then controls the stock solution supplying unit 33 of the coating apparatus 43 to start processing to prepare the coating solution 2 (step S130). When the processing to prepare the coating solution 2 starts, the coating unit 35A starts processing to coat the coated paper 1 with the coating solution 2 (step S140). The controller 90 then controls the drying apparatus 42 to start processing to dry the coated paper 1 in which the coating solution 2 as applied has penetrated into the coating layer 71 (step S150). The drying yields the ink receiving layer 75, which is formed by drying the coating solution 2 having penetrated into a portion, of the coated paper 1, on the side of the surface 73, so that the printing paper 101 is manufactured. The controller 90 then controls the printing apparatus 41 to start ejection of the ink 9 onto the printing paper 101 including the ink receiving layer 75 to thereby start printing processing (step S160 of FIG. 14), and ends the printing start processing performed in the printing system 100A. Operations of the components of the printing system 100A started in the respective steps of the operational flow S100 are continuously performed until the controller 90 ends the processing in respective steps of the operational flow S200 shown in FIG. 15. Through the operations, the processing to prepare the coating solution 2, the processing to coat the coated paper 1 with the coating solution 2, the processing to dry the coated paper 1, and the printing processing to eject the ink 9 onto the printing paper 101 as manufactured are continuously performed.

<A-4-2. Operation of Printing System 100A Relating to End of Printing>

After the processing to perform printing onto the printing paper 101 is started by the operational flow S100 (FIG. 14), the controller 90 waits for a timing of completion of printing of a predetermined number of copies of the material set at the start of the printing processing, for example, by counting the number of copies of the printed material (step S210 of FIG. 15). When conditions for ending printing are satisfied, the controller 90 first controls the stock solution supplying unit 33 to end the processing to prepare the coating solution 2 (step S220). The controller 90 then controls the stock solution supplying unit 33 (coating solution supplying unit 34) to cause the coating unit 35A to end the processing to coat the coated paper 1 with the coating solution 2 (step S230). The controller 90 further controls the drying apparatus 42 to cause the drying apparatus 42 to end the processing to dry the coated paper 1 (step S240), and controls the printing apparatus 41 to cause the printing apparatus 41 to end the processing to perform printing onto the printing paper 101 (step S250).

When the printing processing ends, the controller 90 controls the conveyance system driving apparatus 44 to stop the conveyance rollers 51 and 52 to end conveyance of the coated paper 1 (printing paper 101) (step S260 of FIG. 15), and ends the printing end processing performed in the printing system 100A. By ending the printing end processing, each of the processing to prepare the coating solution 2, the processing to coat the coated paper 1 with the coating solution 2, the processing to dry the coated paper 1, and the processing to perform printing onto the printing paper 101 as manufactured, which are continuously performed, ends. As described above with reference to FIGS. 14 and 15, in the printing system 100A, the coating unit 35A (35B) coats the coated paper 1 with the coating solution 2 in accordance with the printing operation of the printing apparatus 41, i.e., the printing operation of the inkjet head 17. This eliminates the need to provide, in the printing system 100A, a space for storing the printing paper 101 manufactured by forming the ink receiving layer in the coating layer 71 of the coated paper 1, allowing for space saving in the printing system 100A.

In the printing system 100A, coating of the coated paper 1 with the coating solution 2 and ejection of the ink 9 onto the printing paper 101 are sequentially performed in accordance with conveyance of the coated paper 1 (printing paper 101) along a preset processing line.

According to the printing paper according to the embodiment having the above-mentioned configuration, the printing paper includes the base material 61 and the coating layer 71 disposed on the base material 61 and being capable of receiving the oil-base ink, and the coating layer 71 includes, in the portion on the side of the surface 73 thereof, the ink receiving layer 75 containing the cationic polymer and being capable of receiving the water-based ink 9 by allowing the water-based ink 9 to penetrate into the ink receiving layer 75. When ejected onto the printing paper, the water-based ink 9 penetrates into the ink receiving layer 75 included in the upper portion of the coating layer 71 and is received, so that bleeding of the ink 9 is suppressed. The printing paper can be manufactured at low costs without containing expensive materials such as inorganic fine particles. As a result, the surface condition of the coated paper 1 for offset printing can be modified so as to be suitable for the water-based ink at low costs.

According to the printing paper according to the embodiment having the above-mentioned configuration, the ink receiving layer 75 is disposed so as to have a thickness of 5 μm or more from the surface of the coating layer 71. As a result, when printing is performed onto the printing paper 101 at a printing rate of 60% to 250%, bleeding of the ink can be suppressed within the allowable range. Bleeding of the ink can therefore be suppressed within the allowable range in most printing.

According to the apparatus for manufacturing the printing paper according to the embodiment having the above-mentioned configuration, the apparatus includes the supplying unit 31 supplying the coating solution 2, and the coating unit 35A (35B) coating the coating layer 71 with the coating solution 2 supplied by the supplying unit 31 so that the coating solution 2 penetrates into the portion, of the coating layer 71 of the coated paper 1 that is capable of receiving the oil-base ink, on the side of the surface 73. The coating solution 2 contains the cationic polymer, and is in the form of liquid so as to penetrate into the coating layer 71 to form, in the coating layer 71, the ink receiving layer 75 that receives the water-based ink 9 by allowing the water-based ink 9 to penetrate into the ink receiving layer 75. According to the apparatus for manufacturing the printing paper according to the embodiment, the coating solution 2 penetrates into the coating layer 71 of the coated paper 1 to manufacture the printing paper 101 that is the coated paper 1 in which the coating layer 71 includes the ink receiving layer 75 that receives the water-based ink 9 by allowing the water-based ink 9 to penetrate into the ink receiving layer 75. When ejected onto the printing paper 101, the water-based ink 9 penetrates into the ink receiving layer 75 included in the upper portion of the coating layer 71 and is received, so that bleeding of the ink 9 is suppressed. The printing paper 101 can be manufactured at low costs without containing expensive materials such as inorganic fine particles. As a result, the surface condition of the coated paper 1 for offset printing can be modified so as to be suitable for the water-based ink at low costs.

According to the apparatus for manufacturing the printing paper according to the embodiment having the above-mentioned configuration, the coating unit 35A (35B) coats the coating layer 71 with the coating solution 2 in an amount sufficient to penetrate into the coating layer 71 to a depth of 5 μm or more from the surface 73 of the coating layer 71. In the printing paper 101 manufactured by the manufacturing apparatus, the ink receiving layer 75 is disposed so as to have a thickness of 5 μm or more from the surface of the coating layer 71. As a result, when printing is performed onto the printing paper 101 at a printing rate of 60% to 250%, bleeding of the ink can be suppressed within the allowable range. Bleeding of the ink can thus be suppressed within the allowable range in most printing.

According to the apparatus for manufacturing the printing paper according to the embodiment having the above-mentioned configuration, the coating solution 2 contains the additive, such as the surface-active agent and isopropyl alcohol, that increases the speed at which the coating solution 2 penetrates into the coating layer 71. This increases the speed at which the coating solution 2 penetrates to thereby improve the production efficiency of the printing paper 101.

According to the apparatus for manufacturing the printing paper according to the embodiment having the above-mentioned configuration, the apparatus further includes the drying apparatus 42 drying the coated paper 1 coated with the coating solution 2. This promotes evaporation of water and a solvent from the coating solution 2 having penetrated into the coating layer 71 of the coated paper 1 to thereby improve the production efficiency of the printing paper 101.

According to the printing system according to the embodiment having the above-mentioned configuration, the coating solution 2 penetrates into the coating layer 71 of the coated paper 1 and is dried to manufacture the printing paper 101 that is the coated paper 1 in which the coating layer 71 includes the ink receiving layer 75 that receives the water-based ink 9 by allowing the water-based ink 9 to penetrate into the ink receiving layer 75, and printing can be performed by ejecting the water-based ink 9 onto the printing paper 101. The ejected ink 9 penetrates into the ink receiving layer 75 included in the upper portion of the coating layer 71 and is received, so that bleeding of the ink 9 on the printing paper 101 can be suppressed according to the printing system. The printing paper 101 is manufactured at low costs without containing expensive materials such as inorganic fine particles, and thus the printing costs can be suppressed.

<B. Modifications>

Although the embodiment of the present invention has been described so far, the present invention is not limited to the above-mentioned embodiment, and can be modified in various ways.

FIG. 13 shows an example of general configuration of a printing system 100B according to a modification. The printing system 100B is an apparatus that ejects the ink 9 (FIG. 1) onto a so-called sheet of the printing paper 101 in which the coating layer 71 includes the ink receiving layer 75 formed by coating a sheet of the coated paper 1 with the coating solution 2 (FIG. 1) and drying the sheet of the coated paper 1. The printing system 100B differs from the printing system 100A (FIG. 1) in that a paper discharging apparatus 45 and a paper feeding apparatus 46 have been added, and a conveyance belt 55 has been used as a system for conveying the coated paper 1 (printing paper 101). The operating unit 88 and the controller 90 are omitted in FIG. 13. The paper feeding apparatus 46 is provided with a plurality of sheets of the coated paper 1, and the coated paper 1 is fed from the paper feeding apparatus 46 onto the conveyance belt 55 by the sheet-fed method. The printing paper 101 onto which printing has been performed by the printing apparatus 41 is separated from the conveyance belt 55 through suction performed by the paper discharging apparatus 45, for example, and is housed in a paper discharging tray in the paper discharging apparatus 45.

Use of the printing system 100B, for example, in place of the printing system 100A does not impair the usefulness of the present invention. In a case where the printing system that performs printing by the sheet-fed method is used, the printing apparatus 41 and the apparatus 47 for manufacturing the printing paper may be configured as mutually independent apparatuses including mutually independent conveyance systems. In this case, the manufacturing apparatus 47 may not include, from among the drying apparatus 42 and the coating apparatus 43, the drying apparatus 42 when the manufacturing apparatus 47 may manufacture the printing paper 101 by drying, through air seasoning, the coated paper 1 into which the coating solution 2 has penetrated. Similarly, in the printing system 100A, the printing apparatus 41 and the apparatus 47 for manufacturing the printing paper may be configured as mutually independent apparatuses including mutually independent conveyance systems.

### REFERENCE SIGNS LIST

100A, 100B printing system
1 coated paper
101 printing paper
17 inkjet head (ink ejecting unit)
2 coating solution
31 supplying unit
35A, 35B coating unit
47 apparatus for manufacturing printing paper
61 base material
62 upper surface
71 coating layer
72 particles
73 surface
75 ink receiving layer
9 ink

1. Printing paper comprising:
a base material; and
a coating layer disposed on said base material and being capable of receiving an oil-based ink, wherein
said coating layer includes, in a surface-side portion thereof, an ink receiving layer containing a cationic polymer and being capable of receiving a water-based ink by allowing the water-based ink to penetrate into the ink receiving layer.

2. The printing paper according to claim 1, wherein
said ink receiving layer is disposed so as to have a thickness of 5 μm or more from a surface of said coating layer.

3. The printing paper according to claim 1, wherein
said cationic polymer is selected from the group consisting of an allylamine hydrochloride polymer, a methyldiallylamine hydrochloride polymer, a quaternary ammonium salt polymer, an alkylamine polymer, a polyamine condensate, and a polydiallyldimethyl ammonium chloride.

4. A method for manufacturing printing paper, the method comprising:
a coating step of coating a coating layer of coated paper with a coating solution so that the coating solution penetrates into a surface-side portion of said coating layer, the coating solution penetrating into said coating layer so as to form an ink receiving layer in said coating layer, the coated paper including a base material and said coating layer that is disposed on said base material, contains a cationic polymer, and is capable of receiving an oil-based ink, the ink receiving layer receiving a water-based ink by allowing the water-based ink to penetrate into the ink receiving layer; and
a drying step of drying said coated paper coated with said coating solution.

5. The method for manufacturing the printing paper according to claim 4, wherein
said coating step is a step of coating said coating layer with said coating solution in an amount sufficient to penetrate into said coating layer to a depth of 5 μm or more from a surface of said coating layer.

6. The method for manufacturing the printing paper according to claim 4, wherein
said coating solution contains an additive that increases a speed at which said coating solution penetrates into said coating layer.

7. The method for manufacturing the printing paper according to claim 4, wherein
said cationic polymer is selected from the group consisting of an allylamine hydrochloride polymer, a methyldiallylamine hydrochloride polymer, a quaternary ammonium salt polymer, an alkylamine polymer, a polyamine condensate, and a polydiallyldimethyl ammonium chloride.

8. An apparatus for manufacturing printing paper, the apparatus comprising:
a supplying unit supplying a coating solution that penetrates into a coating layer of coated paper so as to form an ink receiving layer in said coating layer, the coated paper including a base material and said coating layer that is disposed on said base material, contains a cationic polymer, and is capable of receiving an oil-based ink, the ink receiving layer receiving a water-based ink by allowing the water-based ink to penetrate into the ink receiving layer; and
a coating unit coating said coating layer with said coating solution supplied by said supplying unit so that the coating solution penetrates into a surface-side portion of said coating layer.

9. The apparatus for manufacturing the printing paper according to claim 8, wherein
said coating unit coats said coating layer with said coating solution in an amount sufficient to penetrate into said coating layer to a depth of 5 μm or more from a surface of said coating layer.

10. The apparatus for manufacturing the printing paper according to claim 8, wherein
said coating solution contains an additive that increases a speed at which said coating solution penetrates into said coating layer.

11. The apparatus for manufacturing the printing paper according claim 8, the apparatus further including
a drying unit drying said coated paper coated with said coating solution.

12. The apparatus for manufacturing the printing paper according to claim 8, wherein
said cationic polymer is selected from the group consisting of an allylamine hydrochloride polymer, a methyldiallylamine hydrochloride polymer, a quaternary ammonium salt polymer, an alkylamine polymer, a polyamine condensate, and a polydiallyldimethyl ammonium chloride.

13. A printing method comprising:
a coating step of coating a coating layer of coated paper with a coating solution so that the coating solution penetrates into a surface-side portion of said coating layer, the coating solution penetrating into said coating layer so as to form an ink receiving layer in said coating layer, the coated paper including a base material and said coating layer that is disposed on said base material, contains a cationic polymer, and is capable of receiving an oil-based ink, the ink receiving layer receiving a water-based ink by allowing the water-based ink to penetrate into the ink receiving layer;
a drying step of drying said coated paper coated with said coating solution; and
an ink ejecting step of ejecting the water-based ink onto said coated paper as dried.

14. The printing method according to claim 13, wherein
said cationic polymer is selected from the group consisting of an allylamine hydrochloride polymer, a methyldiallylamine hydrochloride polymer, a quaternary ammonium salt polymer, an alkylamine polymer, a polyamine condensate, and a polydiallyldimethyl ammonium chloride.

15. A printing system comprising:
a supplying unit supplying a coating solution that penetrates into a coating layer of coated paper so as to form an ink receiving layer in said coating layer, the coated paper including a base material and said coating layer that is disposed on said base material, contains a cationic polymer, and is capable of receiving an oil-based ink, the ink receiving layer receiving a water-based ink by allowing the water-based ink to penetrate into the ink receiving layer;
a coating unit coating said coating layer with said coating solution supplied by said supplying unit so that the coating solution penetrates into a surface-side portion of said coating layer;
a drying unit drying said coated paper coated with said coating solution; and
an ink ejecting unit ejecting the water-based ink onto said coated paper dried by said drying unit.

16. The printing system according to claim 15, wherein
said cationic polymer is selected from the group consisting of an allylamine hydrochloride polymer, a methyldiallylamine hydrochloride polymer, a quaternary ammonium salt polymer, an alkylamine polymer, a polyamine condensate, and a polydiallyldimethyl ammonium chloride.
